(19) United States
(12) Patent Application Publication
(10) Pub. No.: US 2021/0056193 A1
(43) Pub. Date: Feb. 25, 2021

(54) PERMITTED AUTHENTICATION TYPES FOR ACCOUNT ACCESS

(71) Applicant: Microsoft Technology Licensing, LLC, Redmond, WA (US)

(72) Inventors: Li Qing Xia, Seattle, WA (US); Manini Roy, Seattle, WA (US)

(73) Assignee: Microsoft Technology Licensing, LLC, Redmond, WA (US)

(21) Appl. No.: 16/545,948

(22) Filed: Aug. 20, 2019

(51) Int. Cl. G06F 21/45; G06Q 20/40; G06Q 20/38

(52) U.S. Cl. CPC G06F 21/45; G06Q 20/3821; G06Q 20/4014

(57) ABSTRACT

According to examples, an apparatus may include a processor and a computer readable medium on which is stored machine readable instructions that may cause the processor to receive a first authentication type and a second authentication type for access to an account, in which a permitted set of authentication types is to secure access to the account and the first and the second authentication types being respectively assigned a first and a second strength. The processor may determine whether the first and second authentication types meet a predefined grouping of permitted authentication types based on the first and second strengths and based on the first and second authentication types failing to meet the predefined grouping of permitted authentication types, may prevent the first and second authentication types from being set as the permitted set of authentication types for the account.

### BACKGROUND

The number of web-based services available to users, such as services available through web sites, has grown over the years and continues to grow at a rapid pace. To protect user data and user privacy, many of the web-based services may require that users set up and provide credentials to access the web-based services. The credentials may often be in the form of user identifications, passwords, one time passwords received via short message service (SMS), one time passwords received via email, one time passwords received via telephone, and the like. Each of the various types of credentials may be associated with different levels of security and thus different levels of confidence that the credentials prove the identities of the users.

### BRIEF DESCRIPTION OF DRAWINGS

Features of the present disclosure are illustrated by way of example and not limited in the following figure(s), in which like numerals indicate like elements, in which:

FIG. 1 depicts a block diagram of a network environment that may include an apparatus, in which the apparatus may manage the setting of a permitted set of authentication types for access to an account, in accordance with an embodiment of the present disclosure;

FIG. 2 shows a block diagram of the apparatus depicted in FIG. 1 in accordance with an embodiment of the present disclosure;

FIGS. 3 and 4A-4B, respectively, depict flow diagrams of methods for managing the setting of a permitted set of authentication types for access to an account, in accordance with an embodiment of the present disclosure; and

FIG. 5 depicts a block diagram of a computer readable medium that may have stored thereon machine readable instructions that when executed by a processor, may cause the processor to set authentication types that meet certain policy features for access to an account, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, methods, and computer readable media for managing groups of authentication types that may be permitted to be set for access to an account. That is, a user may select a group of authentication types to be set for access to the account and a processor may determine whether the selected group of authentication types meets a certain policy. The certain policy may dictate, for instance, that the selected group of authentication types be resilient to single points of failure and/or that the selected group of authentication types meet a certain minimum strength requirement. That is, for instance, the processor may compare the selected group of authentication types against predefined groupings of permitted authentication types to determine whether the selected group meets the certain policy. The predefined groupings may include various combinations of permissible groupings of authentication types based on, for instance, affinity groups and strengths assigned to the authentication types.

A technical issue associated with setting authentication types for access to accounts may be that certain kinds of authentication types may be tied to common retrieval mechanisms and/or may not provide protection at a predefined level. As a result, if multiple authentication types are tied to a common retrieval mechanism and that retrieval mechanism fails, access to the account may be lost, e.g., may not be recovered. Additionally, if first one of the selected authentication types provides at least the predefined level of protection and a second one of the selected authentication types fails to provide at least the predefined level of protection and the first selected authentication type is lost, access to the account may not be sufficiently protected.

Through implementation of the apparatuses, methods, and computer readable media disclosed herein, a user may be prevented from setting authentication types for access (which may also include recovery of access) to an account that fails to meet a certain policy. That is, authentication types for access to an account may be restricted to authentication types that are not susceptible to a single point of failure and/or that meet certain strength levels. As a result, access and recovery of access to an account may be more resilient to recovery mechanism failures and may provide greater levels of protection against fraudulent access to the account.

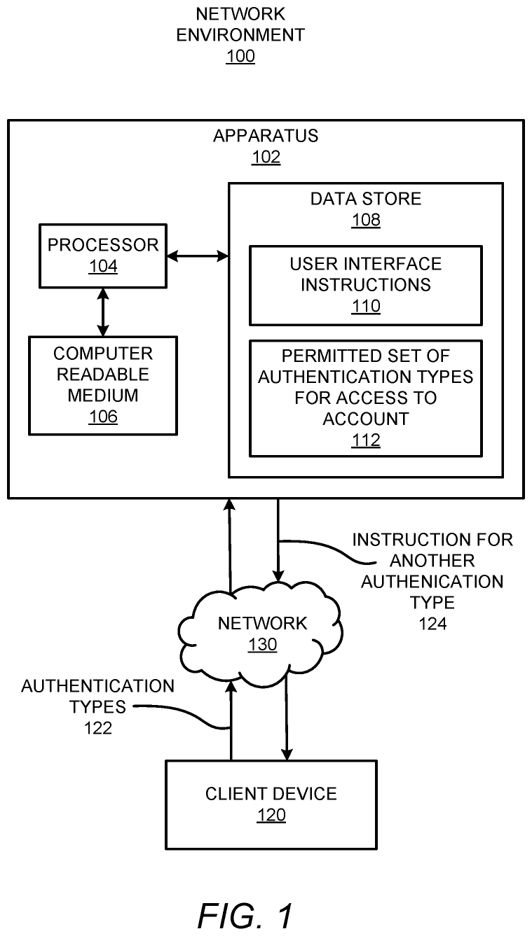

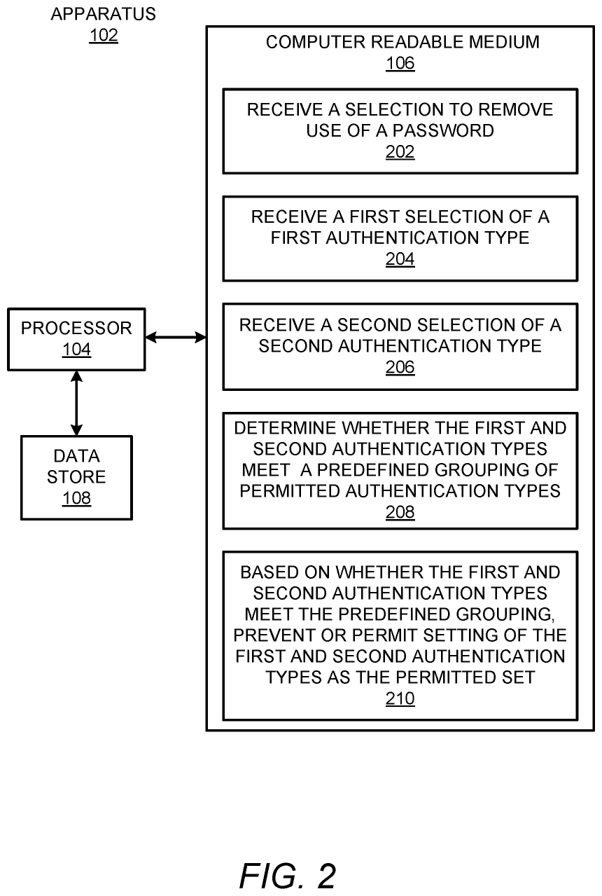

Reference is first made to FIGS. 1 and 2. FIG. 1 shows a block diagram of a network environment 100 that may include an apparatus 102, in which the apparatus 102 may manage the setting of a permitted set of authentication types for access to an account, in accordance with an embodiment of the present disclosure. FIG. 2 shows a block diagram of the apparatus 102 depicted in FIG. 1 in accordance with an embodiment of the present disclosure. It should be understood that the network environment 100 and the apparatus 102 may include additional features and that some of the features described herein may be removed and/or modified without departing from the scopes of the network environment 100 and/or the apparatus 102.

The apparatus 102 may, for instance, be a server that may be employed in the network environment 100. The apparatus 102 may include a processor 104, a computer readable medium 106, and a data store 108. As shown, the apparatus 102 may communicate with a client device 120 via a network 130, which may include a local area network and/or a wide area network, such as the Internet. In addition, the client device 120 may be a laptop computer, a personal computer, a smartphone, a tablet computer, or the like.

According to examples, the apparatus 102 may provide a web-based service to the client device 120. The web-based service may include, for instance, a website for which a user of the client device 120 may have an account, in which the user of the client device 120 may supply credentials of various authentication types to access the account. The website may be directed to, for instance, financial services, news services, various types of web-based applications, or other type of website for which a user may supply credentials to have secure access to an account.

By way of example, a user may input a universal resource locator (URL) address of a website that the apparatus 102 may host into a web browser on the client device 120. In some examples, portions of the website may be hosted on multiple apparatuses 102 and/or on multiple virtual machines. In any of these examples, in response to the input of the URL address, the client device 120 may be directed to the apparatus 102 hosting the website corresponding to the URL address via the network 130. In addition, the apparatus 102 may supply the client device 120 with user interface instructions 110 through which a user may interact with machine-readable instructions executing on the apparatus 102. The user interface instructions 110 may cause various types of information to be displayed on the client device 120. For instance, the user interface instructions 110 may cause a user interface to be displayed on a display of the client device 120 through which a user may input selected authentication types 122.

According to examples and as discussed herein, the user interface instructions 110 may cause instructions regarding the setting of authentication types to access an account, e.g., a user's account, to be displayed. In addition, the user interface instructions 110 may enable receipt of selected authentication types that a user requests to set to access the account. As further discussed herein, the processor 104 of the apparatus 102 may determine whether the selected authentication types may be set as a permitted set of authentication types for access to the account 112. Based on a determination by the processor 104 that the selected authentication types may be set as the permitted set of authentication types for access to the account, the processor 104 may permit the selected authentication types to be set as the permitted set of authentication types for access to the account 112. However, based on a determination by the processor 104 that the selected authentication types may not be set as the permitted set of authentication types for access to the account, the processor 104 may prevent the selected authentication types from being set as the permitted set of authentication types for access to the account 112. Various manners in which the processor 104 may determine whether the selected authentication types are permitted to be set or prevented from being set as the permitted set of authentication types for access to the account 112 are described in detail herein.

The processor 104 may be a semiconductor-based microprocessor, a central processing unit (CPU), an application specific integrated circuit (ASIC), a field-programmable gate array (FPGA), and/or other hardware device. Although the apparatus 102 is depicted as having a single processor 104, it should be understood that the apparatus 102 may include additional processors and/or cores without departing from a scope of the apparatus 102. In this regard, references to a single processor 104 as well as to a single computer readable medium 106 may be understood to additionally or alternatively pertain to multiple processors 104 and multiple computer readable mediums 106.

The computer readable medium 106 may be, for example, a Random Access memory (RAM), an Electrically Erasable Programmable Read-Only Memory (EEPROM), a storage device, an optical disc, or the like. The computer readable medium 106, which may also be referred to as a machine readable storage medium, may be a non-transitory computer readable storage medium, where the term “non-transitory” does not encompass transitory propagating signals. In any regard, the computer readable medium 106 may have stored thereon machine readable instructions 202-210.

The processor 104 may fetch, decode, and execute the instructions 202 to receive a selection to remove use of a password to access an account. By way of example, access to the account may be protected by an authentication requirement in which a user may be required to set multiple factors, e.g., authentication types, for access to the account. The authentication types may include multiple ones of, for instance, a password associated with the account, a hardware time-based one-time password (TOTP) code, a software TOTP code, a password associated with another account (e.g., a password for access to another website), entry of biometric information (e.g., facial recognition, fingerprint recognition, and/or the like), an authenticator application executing on the client device 120, a one-time code received to an email address, a one-time code received to a mobile phone (e.g., via short message service (SMS)), a platform Fast Identity Online (FIDO), a security key FIDO, and the like. One of the set authentication types may be a primary authentication type (e.g., a password) and another one of the set authentication types may be a secondary authentication type (e.g., a one-time SMS code received to a mobile phone).

In some examples, a user may have set the authentication types to meet the authentication requirement as a password for the account and a one-time SMS code received to a mobile phone. In these examples, the password may be a primary authentication type that a user may input to gain access to the account and the SMS code may be a secondary authentication type that may be sent to the user's mobile phone, for instance, in the event that the user forgets the password. However, if the user forgets the password and loses the mobile phone, the user may not be able to recover or reset the password and may thus lose access to the account. As another example, the user may have set the authentication types to meet the authentication requirement as a password for the account and access to another account via another password as a secondary authentication type. In these examples, the user may use to the password as the primary authentication type and the access to the other account as a secondary authentication type. If the user forgets both passwords (which may in some instances be the same password), the user may lose access to the account, e.g., access to the account may not be recoverable.

According to examples disclosed herein, the processor 104 may mitigate risks associated with possible single points of failure as discussed above to thus increase a resiliency of an account recovery process. Particularly, for instance, the processor 104 may mitigate these risks in instances in which a user may decide to remove use of a password to access an account, e.g., decides to go passwordless to access the account. As discussed herein, the processor 104 may mitigate the risks based on potentially shared points of failures and the strengths of the authentication types that the user may select to be set for access to and for recovery of access to the account. That is, the processor 104 may prevent sets of authentication types that fail to meet a certain policy that identifies predefined groupings of authentication types from being set as the permitted set of authentication types for access and recovery of access to the account, in which the predefined groupings may be based on the strengths and/or the shared points of failures of the authentication types.

In these and other examples, the user of the client device 120 may instruct the processor 104 to remove use of the password as an authentication type in the multifactor authentication requirement to access the account. The user may wish to remove use of the password, for instance, because passwords are often easy to forget, may be relatively more vulnerable to being stolen and/or cracked than some of the other authentication types, and/or for various other reasons. The removal of the use of the password to access the account may result in a greater chance of the set authentication types being subject to a single point of failure. As a result, the processor 104 may execute the instructions 204-210 based on receipt of a selection to remove use of the password to access the account. In other examples, however, the processor 104 may execute the instructions 204-210 independently of the user selection to remove use of the password.

In any regard, the user interface instructions 110 may cause a user interface to be displayed on the client device 120. The user interface may display an option for a user to select to remove use of the password. In addition or alternatively, the user interface may display various authentication types, e.g., multiple ones of the authentication types discussed above, from which the user may select certain ones of the authentication types. That is, the user may select multiple ones of the authentication types for access to and for recovery of access to the account via the user interface. The client device 120 may also communicate the selected authentication types 122 to the apparatus 102 via the network 130.

The processor 104 may fetch, decode, and execute the instructions 204 to receive a first selection of a first authentication type for access to an account. The processor 104 may fetch, decode, and execute the instructions 206 to receive a second selection of a second authentication type. The first authentication type may correspond to a primary authentication type that the user may use to access the account and the second authentication type may correspond to a secondary authentication type that the user may use to recover access to the account. By way of example in which the first authentication type is a software TOTP code that a user may access via a mobile phone, the second authentication type may be used to recover access to the account in the event that the user is unable to access the software TOTP code, e.g., in the event that the mobile phone is damaged or lost.

According to examples, each of the authentication types available for selection by the user may be assigned a respective strength and the respective strengths of the authentication types may be stored in the data store 108. The respective strengths (or equivalently, strength levels) assigned to the authentication types may designate, for instance, the levels of confidence that the authentication types prove the identity of the user. Thus, for instance, an authentication type that is assigned a high strength may designate that the authentication type proves the identity of the user at a higher confidence level than another authentication type that is assigned a medium or low strength. The strengths assigned to the authentication types may be based on testing of the authentication types and the relative confidence levels each of the authentication types provides.

In addition, or alternatively, each of the authentication types may be associated with a respective affinity group. An affinity group may be defined as a group of recovery authentication types that share a common point of failure. In other words, the authentication types in a particular affinity group may share a common point of failure, e.g., may both be lost if there is a failure in the common point. The affinity groups to which the authentication types may be associated may be based on the mechanisms in which the authentication types may be obtained.

The following table is provided to show examples of a plurality of authentication types and their respectively assigned strengths and affinity groups. It should be understood that the information included in the following table are for purposes of illustration only and thus are not intended to limit the present disclosure in any respect.

| AUTHENTICATION | | |
|---|---|---|
| TYPE | STRENGTH | AFFINITY GROUP |
| PASSWORD | LOW | PASSWORD |
| HW TOTP CODE | MEDIUM | STANDALONE |
| SW TOTP CODE | MEDIUM | PHONE |
| APPLICATION 1 | LOW | PASSWORD |
| APPLICATION 2 | LOW | PASSWORD |
| APPLICATION 3 | LOW | PASSWORD |
| BIOMETRIC DATA | HIGH | PC |
| AUTHENTICATOR APP | HIGH | PHONE |
| EMAIL OTC | MEDIUM | STANDALONE |
| SMS OTC | MEDIUM | PHONE |
| PLATFORM FIDO | HIGH | PHONE OR PC |
| SECURITY KEY FIDO | HIGH | STANDALONE |

The processor 104 may fetch, decode, and execute the instructions 208 to determine whether the first and second authentication types meet a predefined grouping of permitted authentication types based on the first and second strengths respectively assigned to the first and second authentication types. That is, for example, a plurality of groupings of permitted authentication types may have been predefined and stored in the data store 108. In some examples, each of the plurality of groupings of permitted authentication types may include a combination of authentication types that mitigates the risk of losing an ability to recover access to the account following a single point of failure while also meeting a minimum strength requirement to ensure a sufficient level of user identity validation.

For instance, a predefined grouping of permitted authentication types may include authentication types that are in different affinity groups with respect to each other. As another example, a predefined grouping of permitted authentication types may include authentication types that are in different affinity groups with respect to each other and are each assigned high strengths. As a further example, a predefined grouping of permitted authentication types may include authentication types that are in different affinity groups in which one of the authentication types in one of the affinity groups is assigned a high strength and multiple ones of the authentication types in another one of the affinity groups is assigned low strengths. As a yet further example, a predefined grouping of permitted authentication types may include authentication types that are in three different affinity groups, in which the authentication types in each of the different affinity groups may have low strengths or higher.

The processor 104 may fetch, decode, and execute the instructions 210 to, based on the first and second authentication types failing to meet the predefined grouping of permitted authentication types, prevent the first and second authentication types from being set as the permitted set of authentication types for the account. That is, the processor 104 may prevent the first and second authentication types as selected by a user to be set as the primary authentication type for access to the account and the secondary authentication type for recovery of access to the account. In addition, the processor 104 may output an instruction 124 for another authentication type to be selected via the client device 120. In response, the user may select a third authentication type and the processor 104 may receive the third authentication type, in which the third authentication type may be assigned a third strength.

The processor 104 may determine whether the third authentication type is selected to be used with the first authentication type and the second authentication type. Based on a determination that the third authentication type is to be used with the first authentication type and the second authentication type, the processor 104 may determine whether the first, second, and third authentication types meet the predefined grouping of permitted authentication types based on the first, second, and third strengths. In addition, based on the first, the second, and third authentication types failing to meet the predefined grouping of permitted authentication types, the processor 104 may prevent the first, second, and third authentication types from being set as the permitted authentication types for the account.

However, based on a determination that the third authentication type is selected to replace the first authentication type, the processor 104 may determine whether the second and third authentication types meet the predefined grouping of permitted authentication types. In addition, based on the second and third authentication types failing to meet the predefined grouping of permitted authentication types, the processor 104 may prevent the second and third authentication types from being set as the permitted authentication types for the account.

In any of the examples above, the processor 104 may permit a selected combination of the first, second, and/or third authentication types be set as the permitted set of authentication types for the account 112 based on the selected combination of the first, second, and/or third authentication types meeting the predefined grouping of permitted authentication types. In addition, the processor 104 may set the selected combination of authentication types as the permitted set of authentication types for access to the account, which may include both access to and recovery of access to the account.

Instead of the machine readable instructions 202-210, the apparatus 102 may include hardware logic blocks that may perform functions similar to the instructions 202-210. In other examples, the apparatus 102 may include a combination of instructions and hardware logic blocks to implement or execute functions corresponding to the instructions 202-210. In any of these examples, the processor 104 may implement the hardware logic blocks and/or execute the instructions 202-210. As discussed herein, the apparatus 102 may also include additional instructions and/or hardware logic blocks such that the processor 104 may execute operations in addition to or in place of those discussed above with respect to FIG. 2.

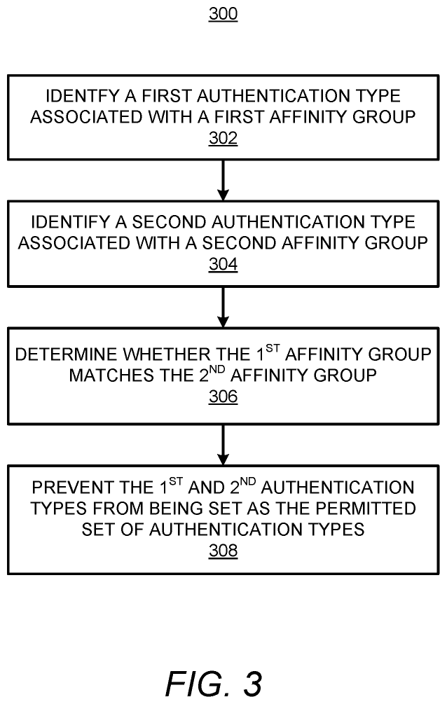

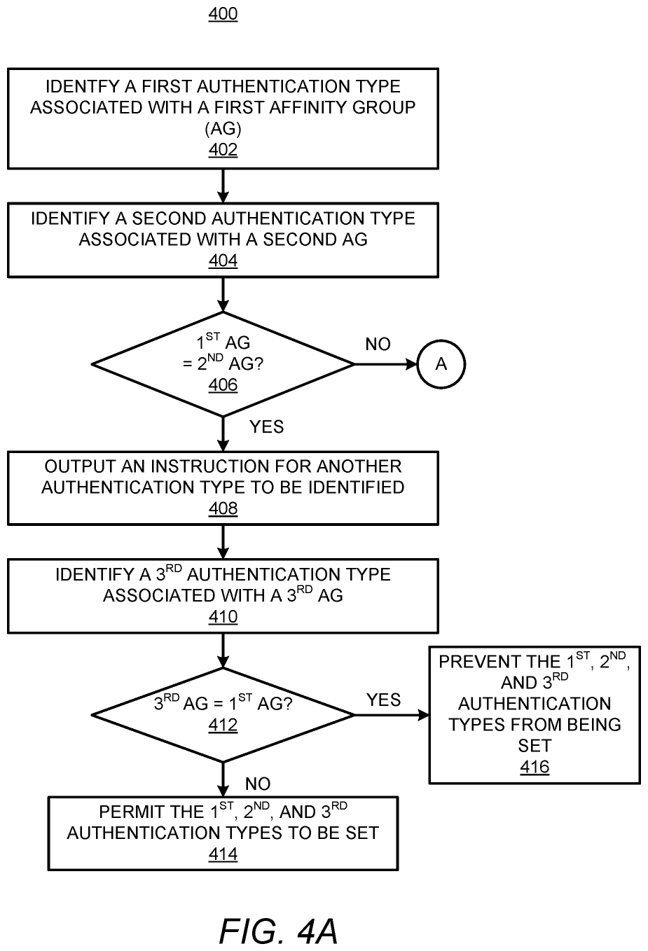

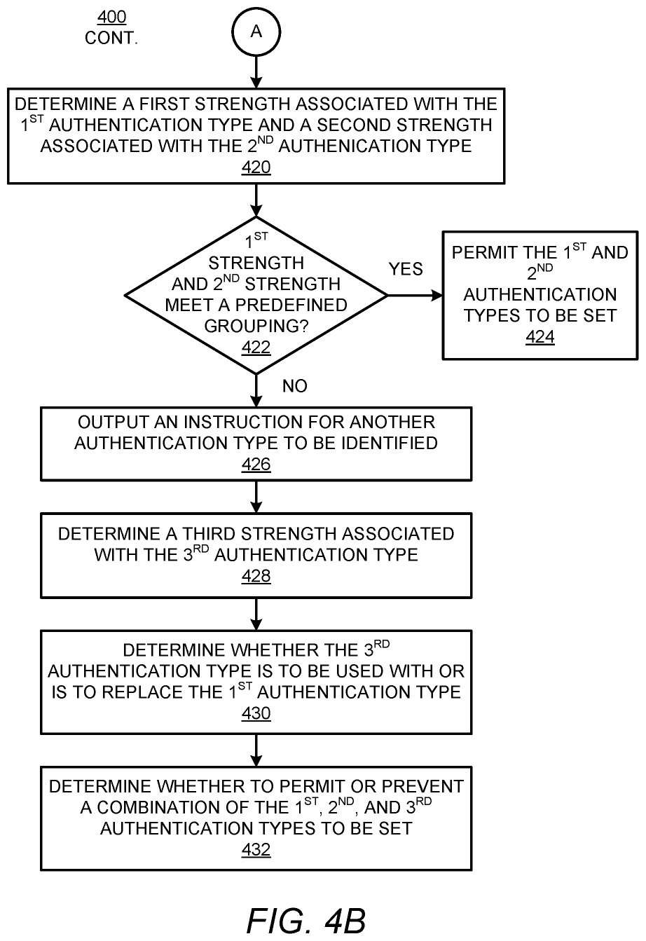

Various manners in which the processor 104 of the apparatus 102 may operate are discussed in greater detail with respect to the methods 300 and 400 respectively depicted in FIGS. 3 and 4A-4B. Particularly, FIGS. 3 and 4A-4B, respectively, depict flow diagrams of methods 300, 400 for managing the setting of a permitted set of authentication types for access to an account, in accordance with an embodiment of the present disclosure. It should be understood that the methods 300 and 400 depicted in FIGS. 3 and 4A- 4 B may include additional operations and that some of the operations described therein may be removed and/or modified without departing from the scopes of the methods 300 and/or 400. The descriptions of the methods 300 and 400 are made with reference to the features depicted in FIGS. 1 and 2 for purposes of illustration.

At block 302, the processor 104 may identify a first authentication type associated with a first affinity group for access to an account. At block 304, the processor 104 may identify a second authentication type associated with a second affinity group. As discussed herein, a user may select the first authentication type and the second authentication type via a user interface and the processor 104 may identify the selected first and second authentication types from the input entered through the user interface. In addition, the first and second authentication types may respectively be assigned to affinity groups as also discussed above.

At block 306, the processor 104 may determine whether the first affinity group matches the second affinity group. That is, the processor 104 may determine whether the first authentication type is assigned to the same affinity group as the second authentication type.

At block 308, the processor 104 may, based on a determination that the first affinity group matches the second affinity group, prevent the first and second authentication types from being set as the permitted set of authentication types for access to the account. In other words, the processor 104 may prevent the user from setting up and/or changing the authentication types for access to the account to only include the first and second authentication types selected at blocks 302 and 304. In some examples, based on a determination that the first affinity group does not match the second affinity group, the processor 104 may permit the first and second authentication types selected at blocks 302 and 304 to be set as the permitted set of authentication types for access to the account.

Turning now to FIGS. 4A and 4B, at block 402, the processor 104 may identify a first authentication type associated with a first affinity group for access to an account. In addition, at block 404, the processor 104 may identify a second authentication type associated with a second affinity group.

At block 406, the processor 104 may determine whether the first affinity group in which the first authentication type is associated matches the second affinity group in which the second authentication type is associated. In other words, the processor 104 may determine whether the first authentication type and the second authentication type share a common point of failure. Based on a determination that the first affinity group matches the second affinity group, the processor 104 may output an instruction 124 for another authentication type to be identified, as indicated at block 408. That is, the processor 104 may output the instruction 124 to the client device 120 to instruct a user to select another authentication type. In addition, or alternatively, the processor 104 may output an indication to the client device 120 that the first authentication type and the second authentication type identified at blocks 402 and 404 may not be set as the permitted set of authentication types for access to the account.

At block 410, the processor 104 may identify a third authentication type associated with a third affinity group. That is, the processor 104 may receive a selection of the third authentication type from the client device 120. In addition, at block 412, the processor 104 may determine whether the third affinity group matches the first affinity group. Based on a determination that the third affinity group does not match first affinity group, at block 414, the processor 104 may permit the first, second, and third authentication types to be set as the permitted set of authentication types for access to the account. However, based on a determination that the third affinity group matches the first affinity group, the processor 104 may prevent the first, second, and third authentication types from being set as the permitted set of authentication types for access to the account. In addition or alternatively, the processor 104 may output an instruction for another authentication type to be identified as indicated at block 408 and may repeat blocks 410-416 for another selected authentication type.

Referring back to block 406, based on a determination that the first affinity group does not match the second affinity group, at block 420 (FIG. 4B), the processor 104 may determine a first strength associated with the first authentication type and a second strength associated with the second authentication type. The processor 104 may determine the first strength and the second strength from information regarding the first authentication type and the second authentication type, for instance, as stored in the data store 108. At block 422, the processor 104 may determine whether the first strength and the second strength meet a predefined grouping of permitted authentication strengths. The predefined grouping of permitted authentication strengths may correspond to the strengths identified in a predefined grouping of permitted authentication types, which are described in further detail elsewhere herein.

At block 424, based on a determination that the first strength and the second strength meet a predefined grouping of permitted strengths, the processor 104 may permit the first and second authentication types to be set as the permitted set of authentication types for access to the account. However, based on a determination that the first strength and the second strength fail to meet a predefined grouping of permitted strengths, at block 426, the processor 104 may output an instruction for another authentication type to be identified. In addition, at block 428, the processor 104 may determine a third strength associated with a third authentication type, e.g., the user may have selected the third authentication type.

At block 430, the processor 104 may determine whether the third authentication type is to be used with the first authentication type and the second authentication type or is to replace the first authentication type (or equivalently, the second authentication type or both the first and second authentication types if the user selected multiple other authentication types). In addition, at block 432, the processor 104 may determine whether to permit or prevent a combination of the first, second, and third authentication types to be set as the permitted set of authentication types for access to the account.

By way of example, the processor 104 may determine that the third authentication type is selected to be used with the first authentication type and the second authentication type. In this example, the processor 104 may determine whether the first strength, the second strength, and the third strength meet the predefined grouping of permitted authentication strengths. Based on the first strength, the second strength, and the third strength failing to meet the predefined grouping of permitted authentication strengths, the processor 104 may prevent the first authentication type, the second authentication type, and the third authentication type from being set as the permitted set of authentication types for access to the account. However, based on the first strength, the second strength, and the third strength meeting the predefined grouping of permitted authentication strengths, the processor 104 may permit the first authentication type, the second authentication type, and the third authentication type to be set as the permitted set of authentication types for access to the account.

As another example, the processor 104 may determine that the third authentication type is selected to replace the first authentication type. In this example, the processor 104 may determine whether the second strength and the third strength meet the predefined grouping of permitted authentication strengths. Based on the second strength and the third strength failing to meet the predefined grouping of permitted authentication strengths, the processor 104 may prevent the second authentication type and the third authentication type from being set as the permitted set of authentication types for the account. However, based on the second strength and the third strength meeting the predefined grouping of permitted authentication strengths, the processor 104 may permit the second authentication type and the third authentication type to be set as the permitted set of authentication types for the account.

Some or all of the operations set forth in the methods 300 and 400 may be included as utilities, programs, or subprograms, in any desired computer accessible medium. In addition, the methods 300 and 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

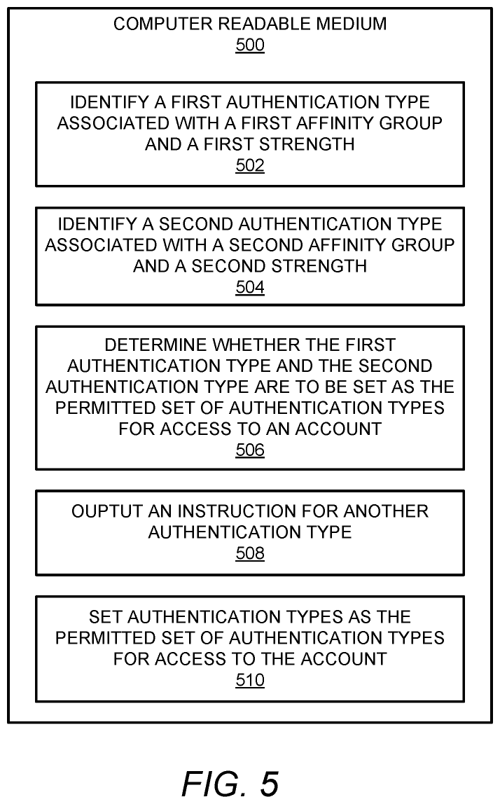

Turning now to FIG. 5, there is shown a block diagram of a computer readable medium 500 that may have stored thereon machine readable instructions that when executed by a processor, may cause the processor to set authentication types that meet certain policy features for access to an account, in accordance with an embodiment of the present disclosure. It should be understood that the computer readable medium 500 depicted in FIG. 5 may include additional instructions and that some of the instructions described herein may be removed and/or modified without departing from the scope of the computer readable medium 500 disclosed herein. The computer readable medium 500 may be a non-transitory computer readable medium. The term “non-transitory” does not encompass transitory propagating signals.

The computer readable medium 500 may have stored thereon machine readable instructions 502-510 that a processor, such as the processor 104 depicted in FIGS. 1 and 2, may execute. The computer readable medium 500 may be an electronic, magnetic, optical, or other physical storage device that contains or stores executable instructions. The computer readable medium 500 may be, for example, Random Access memory (RAM), an Electrically Erasable Programmable Read-Only Memory (EEPROM), a storage device, an optical disc, and the like.

The processor may fetch, decode, and execute the instructions 502 to identify a first authentication type for access to an account, in which the first authentication type is associated with a first affinity group and a first strength. The processor may also fetch, decode, and execute the instructions 504 to identify a second authentication type for access to the account, the second authentication type being associated with a second affinity group and a second strength. The processor may fetch, decode, and execute the instructions 506 to determine whether the first authentication type and the second authentication type are to be set as the permitted set of authentication types for access to the account based on the first affinity group, the second affinity group, the first strength, and the second strength.

According to examples, the processor may determine whether the first affinity group matches the second affinity group and based on a determination that the first affinity group matches the second affinity group, determine that the first authentication type and the second authentication type are not to be set as the permitted set of authentication types for access to the account. In addition or alternatively, the processor may determine whether the first strength and the second strength meet a predefined grouping of permitted authentication strengths and based on a determination that the first affinity group does not match the second affinity group and that the first strength and the second strength meet the predefined grouping of permitted authentication strengths, determine that the first authentication type and the second authentication type are to be set as the permitted set of authentication types for access to the account.

According to examples, the processor may, based on a determination that the first affinity group matches the second affinity group, output an instruction for another authentication type to be selected and identify a third authentication type for access to the account, the third authentication type being associated with a third affinity group. The processor may also determine whether the third affinity group matches the first affinity group and based on the third affinity group not matching the first affinity group, determine that the first authentication type, the second authentication type, and the third authentication type are to be set as the permitted set of authentication types for access to the account. In addition or alternatively, based on a determination that the first strength and the second strength fail to meet a predefined grouping of permitted authentication strengths, the processor may output an instruction for another authentication type to be selected and may identify a third authentication type for access to the account. The processor may also determine whether the identified set of authentication types meets the permitted set of authentication types for access to the account as discussed herein.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a computer readable medium on which is stored machine readable instructions that cause the processor to:
receive a first selection of a first authentication type for access to an account, wherein a permitted set of authentication types is to secure access to the account;
receive a second selection of a second authentication type, the first and the second authentication types being respectively assigned a first and a second strength;
determine whether the first and second authentication types meet a predefined grouping of permitted authentication types based on the first and second strengths; and
based on the first and second authentication types failing to meet the predefined grouping of permitted authentication types, prevent the first and second authentication types from being set as the permitted set of authentication types for the account.

2. The apparatus according to claim 1, wherein the instructions are further to cause the processor to:
receive a selection to remove use of a password to access the account; and
receive the first selection and the second selection based on receipt of the selection to remove use of the password to access the account, wherein the first and second authentication types are prevented from being set as permitted authentication methods for the account to prevent a user from being unable to recover access to the account from a single point of failure in authentication types.

3. The apparatus of claim 1, wherein the instructions are further to cause the processor to:
based on the first and second authentication types meeting the predefined grouping of permitted authentication types, permit the first and second authentication types to be set as the permitted set of authentication types for the account.

4. The apparatus of claim 1, wherein the predefined grouping of permitted authentication types is a predefined grouping of a plurality of predefined groupings of permitted authentication types, wherein the plurality of predefined groupings of permitted authentication types includes multiple combinations of permitted authentication types of multiple strengths.

5. The apparatus of claim 1, wherein the instructions are further to cause the processor to:
based on the first and second authentication types failing to meet the predefined grouping of permitted authentication types, output an instruction for another authentication type to be selected; and
receive a third selection of a third authentication type for access to the account, the third authentication type being assigned a third strength.

6. The apparatus of claim 5, wherein the instructions are further to cause the processor to:
determine that the third authentication type is selected to be used with the first authentication type and the second authentication type;
determine whether the first, second, and third authentication types meet the predefined grouping of permitted authentication types based on the first, second, and third strengths; and
based on the first, the second, and third authentication types failing to meet the predefined grouping of permitted authentication types, prevent the first, second, and third authentication types from being set as the permitted authentication types for the account.

7. The apparatus of claim 5, wherein the instructions are further to cause the processor to:
determine that the third authentication type is selected to replace the first authentication type;
determine whether the second and third authentication types meet the predefined grouping of permitted authentication types; and
based on the second and third authentication types failing to meet the predefined grouping of permitted authentication types, prevent the second and third authentication types from being set as the permitted authentication types for the account.

8. The apparatus of claim 1, wherein the instructions are further to cause the processor to:
determine affinity groups into which the first authentication type and the second authentication type are respectively associated;
determine whether the first authentication type and the second authentication type are associated with a common affinity group; and
based on a determination that the first authentication type and the second authentication type are associated with the common affinity group, prevent the first and second authentication types from being set as the permitted authentication types for the account.

9. The apparatus of claim 8, wherein the instructions are further to cause the processor to:
based on the first authentication type and the second authentication type being associated with the common affinity group, output an instruction for another authentication type to be selected;
receive a third selection of a third authentication type for access to the account;
determine an affinity group into which the third authentication type is associated; and
based on a determination that the affinity group into which the third authentication type is associated differs from the affinity group into which the first authentication type and the second authentication type are associated, permit the first, second, and third authentication types to be set as the permitted authentication types for the account.

10. A method comprising:
identifying, by a processor, a first authentication type associated with a first affinity group for access to an account, wherein a permitted set of authentication types is to secure access to the account;
identifying, by the processor, a second authentication type associated with a second affinity group;
determining, by the processor, whether the first affinity group matches the second affinity group; and
based on a determination that the first affinity group matches the second affinity group, preventing, by the processor, the first and second authentication types from being set as the permitted set of authentication types for access to the account.

11. The method of claim 10, further comprising:
based on a determination that the first affinity group matches the second affinity group, outputting an instruction for another authentication type to be identified;
identifying a third authentication type for access to the account, the third authentication type being associated with a third affinity group;
determining whether the third affinity group matches the first affinity group; and
based on a determination that the third affinity group differs from the first affinity group, permitting the first, second, and third authentication types to be set as the permitted set of authentication types for access to the account.

12. The method of claim 10, further comprising:
based on a determination that the first authentication type and the second authentication type are associated with different affinity groups,
determining a first strength associated with the first authentication type and a second strength associated with the second authentication type;
determining whether the first strength and the second strength meet a predefined grouping of permitted authentication strengths; and
based on the first strength and the second strength failing to meet the predefined grouping of permitted authentication strengths, preventing the first authentication type and the second authentication type from being set as the permitted set of authentication types for access to the account.

13. The method of claim 12, further comprising:
based on the first strength and the second strength meeting the predefined groupings of permitted authentication strengths, permitting the first authentication type and the second authentication type to be set as the permitted set of authentication types for access to the account.

14. The method of claim 12, further comprising:
based on the first strength and the second strength failing to meet the predefined grouping of permitted authentication strengths, outputting an instruction for another authentication type to be selected;
identifying a third authentication type for access to the account; and
determining a third strength associated with the third authentication type.

15. The method of claim 14, further comprising:
determining that the third authentication type is selected to be used with the first authentication type and the second authentication type;
determining whether the first strength, the second strength, and the third strength meet the predefined grouping of permitted authentication strengths;
based on the first strength, the second strength, and the third strength failing to meet the predefined grouping of permitted authentication strengths, preventing the first authentication type, the second authentication type, and the third authentication type from being set as the permitted set of authentication types for access to the account; and
based on the first strength, the second strength, and the third strength meeting the predefined grouping of permitted authentication strengths, permitting the first authentication type, the second authentication type, and the third authentication type to be set as the permitted set of authentication types for access to the account.

16. The method of claim 14, further comprising:
determining that the third authentication type is selected to replace the first authentication type;
determining whether the second strength and the third strength meet the predefined grouping of permitted authentication strengths;
based on the second strength and the third strength failing to meet the predefined grouping of permitted authentication strengths, preventing the second authentication type and the third authentication type from being set as the permitted set of authentication types for the account; and
based on the second strength and the third strength meeting the predefined grouping of permitted authentication strengths, permitting the second authentication type and the third authentication type to be set as the permitted set of authentication types for the account.

17. A computer readable medium on which is stored machine readable instructions that when executed by a processor, cause the processor to:
identify a first authentication type for access to an account, wherein the first authentication type is associated with a first affinity group and a first strength, and wherein a permitted set of authentication types is to secure access to the account;
identify a second authentication type for access to the account, the second authentication type being associated with a second affinity group and a second strength; and
determine whether the first authentication type and the second authentication type are to be set as the permitted set of authentication types for access to the account based on the first affinity group, the second affinity group, the first strength, and the second strength.

18. The computer readable medium of claim 17, wherein the instructions are further to cause the processor to:
determine whether the first affinity group matches the second affinity group; and
based on a determination that the first affinity group matches the second affinity group, determine that the first authentication type and the second authentication type are not to be set as the permitted set of authentication types for access to the account.

19. The computer readable medium of claim 18, wherein the instructions are further to cause the processor to:
determine whether the first strength and the second strength meet a predefined grouping of permitted authentication strengths; and
based on a determination that the first affinity group does not match the second affinity group and that the first strength and the second strength meet the predefined grouping of permitted authentication strengths, determine that the first authentication type and the second authentication type are to be set as the permitted set of authentication types for access to the account.

20. The computer readable medium of claim 18, wherein the instructions are further to cause the processor to:
based on a determination that the first affinity group matches the second affinity group,
output an instruction for another authentication type to be selected;
identify a third authentication type for access to the account, the third authentication type being associated with a third affinity group;
determine whether the third affinity group matches the first affinity group; and
based on the third affinity group not matching the first affinity group, determine that the first authentication type, the second authentication type, and the third authentication type are to be set as the permitted set of authentication types for access to the account.
